(19) United States
(12) Patent Application Publication
(10) Pub. No.: US 2014/0158662 A1
(43) Pub. Date: Jun. 12, 2014

(54) NANOIMPRINT STAMP HAVING ALIGNMENT MARK AND METHOD OF FABRICATING THE SAME

(71) Applicant: Samsung Electronics Co., Ltd., Suwon-Si (KR)

(72) Inventors: Du-hyun LEE, Suwon-si (KR); Woong KO, Hwaseong-si (KR); Jae-kwan KIM, Daegeon (KR); Ki-yeon YANG, Seongnam-si (KR); Byung-kyu LEE, Seoul (KR)

(21) Appl. No.: 13/920,503

(22) Filed: Jun. 18, 2013

(30) Foreign Application Priority Data
Dec. 12, 2012 (KR) 10-2012-0144806

(51) Int. Cl. B29C 59/00

(52) U.S. Cl. CPC B29C 59/002
USPC 216/11; 425/385

(57) ABSTRACT

A nanoimprint stamp having an alignment mark includes a transparent substrate having a plurality of convex portions, and a semitransparent layer on each of the plurality of convex portions. The semitransparent layer has a transmittance of about 20% to about 80% with respect to ultraviolet rays.

### CROSS-REFERENCE TO RELATED APPLICATION

This application claims the benefit of Korean Patent Application No. 10-2012-0144806, filed on Dec. 12, 2012, in the Korean Intellectual Property Office, the disclosure of which is incorporated herein in its entirety by reference.

### BACKGROUND

1. Field

Some example embodiments relate to a nanoimprint stamp having an alignment mark and a method of fabricating the same.

2. Description of the Related Art

A nanoimprint process is one in which a stamp having a pattern formed thereon is stamped on target surfaces, and the pattern is repeatedly copied on the target surfaces.

In a nanoimprint process using ultraviolet rays, a stamp is manufactured of a transparent material capable of transmitting ultraviolet rays, and a reverse shape of a pattern is formed on a surface of the stamp in an uneven structure. After a photoresist applied on a transparent substrate is patterned, the patterned photoresist is used to etch the transparent substrate and make a stamp having a pattern thereon.

When a nanoimprint stamp is used to manufacture semiconductors, displays and the like, a multilayered pattern is required, for which alignment between each layer is necessarily required.

A quartz stamp normally used for a nanoimprint in the related art is transparent. Thus, when a photocurable resin is applied on a substrate to be imprinted, a difference in the refractive index between the photocurable resin and the stamp is relatively low. The pattern on the stamp, in particular, the alignment mark, may not be discerned. In order to align an alignment mark for the target substrate with the alignment mark for the stamp in an imprinting process, the alignment mark on the stamp must be discerned. However, alignment difficulties arise because there is little difference in the refractive indices between the stamp and the photocurable resin. To solve the above-described limitations, in the related art, an air gap is formed on the alignment mark area by making a moat around the alignment mark to block the influx of a resist. However, this may result in the alignment mark area becoming undesirably large, and area efficiency for device manufacturing is reduced.

Alternatively, for solving the above-described problems, a relatively high contrast alignment mark may be separately formed on the stamp, however, this may complicate the manufacturing process.

### SUMMARY

Some example embodiments provide a method for forming a high contrast alignment mark on an imprint stamp with a simple process.

Additional aspects will be set forth in part in the description which follows and, in part, will be apparent from the description, or may be learned by practice of the presented embodiments.

According to an example embodiment, a nanoimprint stamp having an alignment mark includes a transparent substrate having a plurality of convex portions, and a semitransparent layer on each of the plurality of convex portions, the semitransparent layer having a transmittance of about 20% to about 80% with respect to ultraviolet rays.

The semitransparent layer may comprise one of chromium (Cr), nickel (Ni), tantalum (Ta), an oxide layer thereof, and a nitride layer thereof. The semitransparent layer may comprise one of Cr, Ni, and Ta, and may have a thickness of about 5 nm or less. The semitransparent layer may comprise one of the oxide layer and the nitride layer, and may have a thickness of about 5 nm to about 15 nm.

The plurality of convex portions may be in a nanoimprint area and an alignment mark area of the transparent substrate. The transparent substrate may be a quartz substrate.

According to another example embodiment, a method of fabricating a nanoimprint stamp having an alignment mark includes forming a semitransparent layer on a transparent substrate, forming a photoresist pattern on the semitransparent layer, forming a plurality of convex portions and a semitransparent layer pattern on a surface of the transparent substrate by sequentially etching the semitransparent layer and the transparent substrate using the photoresist pattern, the semitransparent layer pattern having a transmittance of about 20% to about 80% with respect to ultraviolet rays, and removing the photoresist pattern.

### BRIEF DESCRIPTION OF THE DRAWINGS

These and/or other aspects will become apparent and more readily appreciated from the following description of the embodiments, taken in conjunction with the accompanying drawings of which:

FIG. 1 is a cross-sectional view illustrating a nanoimprint stamp having a high contrast alignment mark according to an example embodiment;

FIG. 2 is a graph illustrating an ultraviolet transmittance when a chrome layer is formed as a semitransparent layer on a quartz substrate;

FIG. 3 is a graph illustrating an ultraviolet transmittance when a chrome oxide layer is formed as a semitransparent layer on a quartz substrate; and

FIGS. 4A to 4C are cross-sectional views sequentially illustrating a method of fabricating a nanoimprint stamp according to another example embodiment.

### DETAILED DESCRIPTION

Hereinafter, embodiments will be described in detail with reference to the accompanying drawings. In the figures, the dimensions of layers and areas may be exaggerated for clarity of illustration. Like reference numerals refer to like elements throughout, and a description thereof will be omitted.

Hereinafter when it is referred to as being “on” another layer or substrate, it may be directly on the other layer or substrate, or intervening layers may also be present.

It will be understood that, although the terms “first”, “second”, etc. may be used herein to describe various elements, components, regions, layers and/or sections, these elements, components, regions, layers and/or sections are not to be limited by these terms. These terms are only used to distinguish one element, component, region, layer or section from another element, component, region, layer or section. Thus, a first element, component, region, layer or section discussed below could be termed a second element, component, region, layer or section without departing from the teachings of example embodiments.

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises”, “comprising”, “includes” and/or “including,” if used herein, specify the presence of stated features, integers, steps, operations, elements and/or components, but do not preclude the presence or addition of one or more other features, integers, steps, operations, elements, components and/or groups thereof.

Example embodiments are described herein with reference to cross-sectional illustrations that are schematic illustrations of idealized embodiments (and intermediate structures) of example embodiments. As such, variations from the shapes of the illustrations as a result, for example, of manufacturing techniques and/or tolerances, are to be expected. Thus, example embodiments are not to be construed as limited to the particular shapes of regions illustrated herein but are to include deviations in shapes that result, for example, from manufacturing. For example, an implanted region illustrated as a rectangle may have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of example embodiments.

Unless otherwise defined, all terms (including technical and scientific terms) used herein have the same meaning as commonly understood by one of ordinary skill in the art to which example embodiments belong. It will be further understood that terms, such as those defined in commonly-used dictionaries, is to be interpreted as having a meaning that is consistent with their meaning in the context of the relevant art and will not be interpreted in an idealized or overly formal sense unless expressly so defined herein.

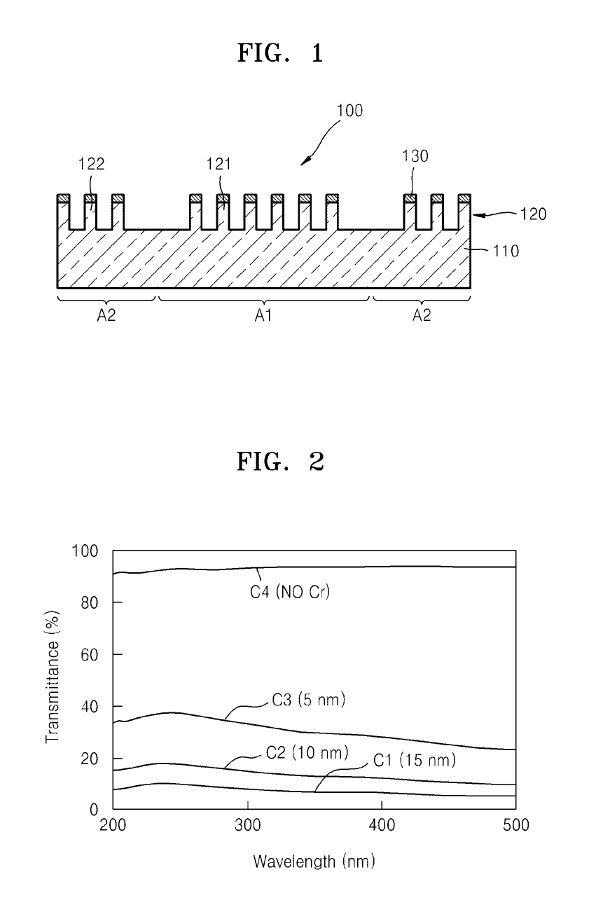

FIG. 1 is a cross-sectional view illustrating a nanoimprint stamp 100 having a high contrast alignment mark according to an example embodiment.

Referring to FIG. 1, an uneven structure 120 is formed on a surface of a transparent substrate 110. The uneven structure 120 includes convex portions 121 on an imprint area Al and convex portions 122 on an alignment mark area A2. A width, spacing, and height of the convex portions 121 of the imprint area A1 may be different from that of the convex portions 122 of the alignment mark area A2. A semitransparent layer 130 is formed on each of the convex portions 121 and 122. The transparent substrate 110 may be a quartz substrate.

The semitransparent layer 130 may have an ultraviolet transmittance of about 20% to about 80%. If the semitransparent layer 130 has an ultraviolet transmittance of about 20% or less, an ultraviolet curable time for photoresist, which is a target for transferring a stamp pattern, may increase. If the semitransparent layer 130 has an ultraviolet transmittance of about 80% or more, visibility of the alignment mask with respect to the photoresist may be deteriorated due to a relatively low visible light transmittance. Thus, it may be difficult to align the nanoimprint stamp 100 on the transferring target substrate.

The semitransparent layer 130 may be formed of a metal such as Cr, Ti, and Ta. Alternatively, the semitransparent layer 130 may include an oxide or nitride layer containing the metal. In the case where the semitransparent layer 130 is formed of the metal, the semitransparent layer 130 may have a thickness of about 5 nm or less. In the case where the semitransparent layer 130 is formed of the oxide or nitride layer, the semitransparent layer 130 may have a thickness of about 5 nm to about 15 nm.

If the photoresist is disposed under the semitransparent layer 130, a relatively small amount of visible light is transmitted through the semitransparent layer 130 when compared to the photoresist, thereby forming a relatively high contrast alignment mark, and thus, the nanoimprint stamp 100 may be more easily aligned on the transparent substrate having the photoresist thereon.

FIG. 2 is a graph illustrating an ultraviolet transmittance when a chrome film is formed on a quartz substrate as a semitransparent layer (see reference numeral 130 of FIG. 1). Curves C1 to C3 illustrate ultraviolet transmittances when a chrome layer has a thickness of about 15 nm, about 10 nm, and about 5 nm, respectively. A curve C4 illustrates an ultraviolet transmittance when the chrome layer is omitted. Referring to FIG. 2, when the chrome layer has thicknesses of about 15 nm and about 10 nm, the respective ultraviolet transmittances are less than about 20% at an ultraviolet wavelength of about 365 nm, which is used for curing photoresist. When the chrome layer has a thickness of about 5 nm, the ultraviolet transmittance is about 30%. The ultraviolet transmittance is over 90% when the chrome layer is omitted (see curve C4 of FIG. 2). Therefore, as the chrome layer increases in thickness, the ultraviolet transmittance decreases.

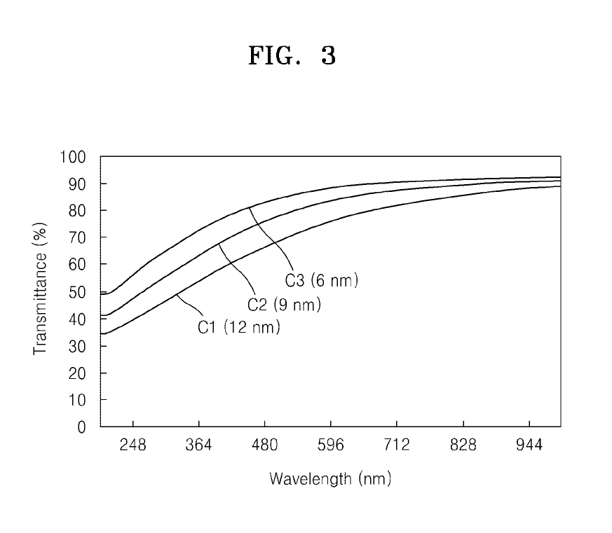

FIG. 3 is a graph illustrating an ultraviolet transmittance when a chrome oxide layer is formed on a quartz substrate as a semitransparent layer (see reference numeral 130 of FIG. 1). Curves C1 to G3 illustrate ultraviolet transmittances when a chrome oxide layer has thicknesses of about 12 nm, about 9 nm, and about 6 nm, respectively. Referring to FIG. 3, when the chrome oxide layer has thicknesses about 6 nm, about 9 nm, and about 12 nm at an ultra-wavelength of about 365 nm which is used for curing photoresist, the ultraviolet transmittance are about 73%, about 65%, and about 64%, respectively. Therefore, as the chrome oxide layer increases in thickness, the ultraviolet transmittance decreases.

When an ultraviolet ray having a wavelength of about 365 nm is emitted onto the photoresist, energy of about 75 mJ/cm² is needed. Here, ultraviolet power may be about 500 nW/cm². Also, to cure the photoresist, when the semitransparent layer is omitted, an ultraviolet emission time may be about 0.15 seconds. When the chrome layer has a thickness of about 5 nm, it takes an ultraviolet emission time of about 0.45 seconds to cure the photoresist. When the chrome oxide layer has a thickness of about 12 nm, it takes an ultraviolet emission time of about 0.27 seconds to cure the photoresist. Thus, when the semitransparent layer 130 according to the present disclosure is used, an increase in the time required for curing the photoresist may be smaller, and also a decrease in productivity may be smaller.

According to an example embodiment, the nanoimprint stamp 100 having an uneven structure on which the semitransparent layer is formed may be more easily aligned on an imprint target substrate because visibility of the align mark with respect to an imprint target substrate is improved.

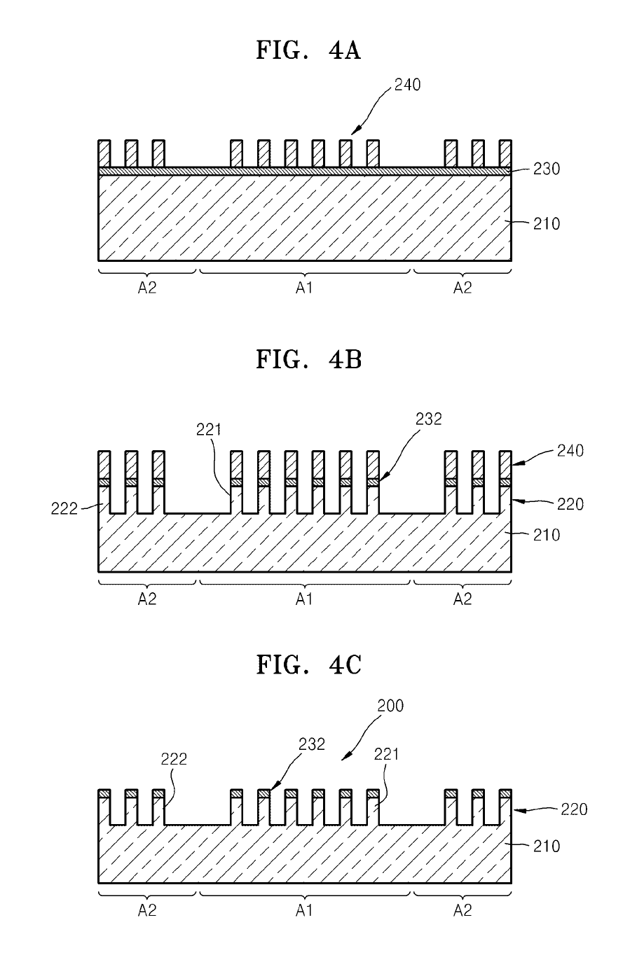

FIGS. 4A to 4C are cross-sectional views sequentially illustrating a method of fabricating a nanoimprint stamp 200 according to an example embodiment.

Referring to FIG. 4A, a transparent substrate 210 is prepared. The transparent substrate 210 may be a quartz substrate.

A semitransparent layer 230 is formed on the transparent substrate 210. The semitransparent layer 230 may have an ultraviolet transmittance of about 20% to about 80%. If the semitransparent layer 230 has an ultraviolet transmittance of about 20% or less, an ultraviolet curable time for photoresist, which is a target for transferring a stamp pattern, may increase. If the semitransparent layer 230 has an ultraviolet transmittance of about 80% or more, visibility of an alignment mark on an imprint target substrate under photoresist may be deteriorated due to a relatively low visible light transmittance. Thus, it may be difficult to align a nanoimprint stamp 200 on the imprint target substrate.

The semitransparent layer 230 may be formed of a metal such as Cr, Ti, and Ta, and the like. Alternatively, the semitransparent layer 230 may include an oxide or nitride layer containing the metal. The semitransparent layer 230 may be formed by using a sputtering method. In the case where the semitransparent layer 230 is formed of the metal, the semitransparent layer 230 may have a thickness of about 5 nm or less. In the case where the semitransparent layer 230 is formed of the oxide or nitride layer, the semitransparent layer 230 may have a thickness of about 5 nm to about 15 nm.

Photoresist (not shown) is formed on the semitransparent layer 230, and then the photoresist is patterned to form a photoresist pattern 240. The photoresist pattern 240 may be fabricated by using general lithography methods such as e-beam lithography, photo lithography, interference lithography, and self-assembly lithography. A top surface of the transparent substrate 210 includes an imprint area A1 and an alignment mark area A2. The photoresist pattern 240 is formed over the imprint area A1 and the alignment mark area A2.

Referring to FIG. 4B, the semitransparent layer 230 and the transparent substrate 210 exposed by the photoresist pattern 240 are sequentially etched. Here, a dry etch process well-known in the semiconductor process may be performed as the above-described etching method, and thus its detailed description will be omitted.

An uneven structure 220 including a plurality of convex portions 221 and 222 is formed on each of the imprint area A1 and the alignment mark area A2 of the top surface of the transparent substrate 210. A semitransparent layer pattern 232 is formed on the uneven structure 220.

Referring to FIG. 4C, the photoresist pattern 240 is removed. The semitransparent layer pattern 232 is formed on the convex portions 221 and 222 of the transparent substrate 210. The semitransparent layer pattern 232 is formed on the alignment mark area A2 as well as the imprint area A1. Thus, a resultant nanoimprint stamp 200 having a relatively high contrast alignment mark is fabricated.

According to the present disclosure, the alignment mark may be formed on a relatively narrow area. Also, when the imprint pattern is fabricated, the alignment mark is fabricated together, and thus the fabrication process may be simplified. In addition, it may prevent or inhibit the stamp from being damaged and contaminated due to the related-art complicated fabrication processes.

Example embodiments have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present disclosure as set forth in the following claims. Hence, the scope of the inventive concepts shall be determined by the spirit and scope of the following claims.

What is claimed is:

1. A nanoimprint stamp having an alignment mark, the nanoimprint stamp comprising:
a transparent substrate having a plurality of convex portions; and
a semitransparent layer on each of the plurality of convex portions, the semitransparent layer having a transmittance of about 20% to about 80% with respect to ultraviolet rays.

2. The nanoimprint stamp of claim 1, wherein the semitransparent layer comprises one of chromium (Cr), nickel (Ni), tantalum (Ta), an oxide layer thereof, and a nitride layer thereof.

3. The nanoimprint stamp of claim 2, wherein the semitransparent layer comprises one of Cr, Ni, and Ta, and has a thickness of about 5 nm or less.

4. The nanoimprint stamp of claim 2, wherein the semitransparent layer comprises one of the oxide layer and the nitride layer, and has a thickness of about 5 nm to about 15 nm.

5. The nanoimprint stamp of claim 1, wherein the plurality of convex portions are in a nanoimprint area and an alignment mark area of the transparent substrate.

6. The nanoimprint stamp of claim 1, wherein the transparent substrate is a quartz substrate.

7. A method of fabricating a nanoimprint stamp having an alignment mark, the method comprising:
forming a semitransparent layer on a transparent substrate;
forming a photoresist pattern on the semitransparent layer;
forming a plurality of convex portions and a semitransparent layer pattern on a surface of the transparent substrate by sequentially etching the semitransparent layer and the transparent substrate using the photoresist pattern, the semitransparent layer pattern having a transmittance of about 20% to about 80% with respect to ultraviolet rays; and
removing the photoresist pattern.

8. The method of claim 7, wherein the forming a semitransparent layer pattern includes forming the semitransparent layer pattern including one of chromium (Cr), nickel (Ni), tantalum (Ta), an oxide layer thereof, and a nitride layer thereof.

9. The method of claim 8, wherein the forming a semitransparent layer pattern includes forming the semitransparent layer pattern including one of Cr, Ni, and Ta, and having a thickness of about 5 nm or less.

10. The method of claim 8, wherein the forming a semitransparent layer pattern includes forming the semitransparent layer pattern including one of the oxide layer and the nitride layer, and having a thickness of about 5 nm to about 15 nm.

11. The method of claim 7, wherein the forming a plurality of convex portions and a semitransparent layer pattern includes forming the plurality of convex portions on a nanoimprint area and an alignment mark area of the transparent substrate.

12. The method of claim 7, wherein the forming a semitransparent layer on a transparent substrate includes forming the semitransparent layer on a quartz substrate.
